(19) United States
(12) Patent Application Publication
(10) Pub. No.: US 2012/0054692 A1
(43) Pub. Date: Mar. 1, 2012

(54) SCHEDULING PROFILE MODIFICATION INTERFACE

(75) Inventor: Paul Richard Harrison, London (GB)

(73) Assignee: CHP Consulting Limited, London (GB)

(21) Appl. No.: 13/216,924

(22) Filed: Aug. 24, 2011

(30) Foreign Application Priority Data
Aug. 25, 2010 (GB) 1014184.4

(51) Int. Cl. G06F 3/033

(52) U.S. Cl. 715/863

(57) ABSTRACT

Embodiments of the present invention provide an apparatus arranged to modify a scheduling profile according to a gesture of a user, the apparatus comprising a display unit for displaying scheduling profile display data a scheduling profile display data generating unit for generating scheduling profile display data representing the scheduling profile, and outputting the scheduling profile display data to the display unit, a user interface unit for tracking the gesture of the user and providing tracking data, a gesture data generating unit for generating gesture data representing the gesture of the user based on the tracking data, and a modifying unit for modifying the scheduling profile based on the gesture data, wherein the scheduling profile display data generating unit is also operable to generate scheduling profile display data representing the modified scheduling profile, and to output the modified scheduling profile display data to the display unit.

This invention is in the field of action scheduling and graphical user interfaces for action scheduling and modifying action schedules.

There exist in the art applications for modifying a scheduling profile, such as rental or manufacturing information, in which the scheduling information can be entered and manipulated using alphanumerical keys on a keyboard. For example, a user may want to extend the period of time over which scheduled actions take place. The user would first need to select that they want to extend the period, then enter information on a keyboard representing the length of extension. The scheduling profile is updated accordingly.

One example might be a manufacturing company needing to schedule the manufacture of an agreed amount of a product over a fixed time frame. The amount of the product to be produced each month in order to meet a particular customer's agreed order needs to be tracked. The purchaser may have some reason for not wanting a delivery on a particular month, but may still want the total amount delivered over the course of the agreement to be the same. A user of a prior art multi-stage keyboard-dependent manufacturing schedule profiling system would then need to indicate on the system that there will be a period of time in which no product is required, and then enter the dates or months of that period.

A further example of a user modifying a scheduling profile might be an asset finance company needing to represent the rentals paid by a customer for an asset over a period of time. For example, a customer may purchase an asset having an agreed value and pay for it over a number of months, paying an equal fraction of the agreed value each month. Should the asset finance company then receive a request to extend a customer's rental payment period by three months, the user of a prior art multi-stage input keyboard-dependent system for tracking the rentals would first need to select that they wanted to extend the payment period, and then, for example, the number three would need to be entered into the system via a keyboard to represent the three month extension period.

In embodiments of the present invention, there is provided an apparatus arranged to modify a scheduling profile according to a gesture of a user, the apparatus comprising a display unit for displaying scheduling profile display data, a scheduling profile display data generating unit for generating scheduling profile display data representing the scheduling profile, and outputting the scheduling profile display data to the display unit, a user interface unit for tracking the gesture of the user and providing tracking data, a gesture data generating unit for generating gesture data representing the gesture of the user based on the tracking data, and a modifying unit for modifying the scheduling profile based on the gesture data, wherein the scheduling profile display data generating unit is also operable to generate scheduling profile display data representing the modified scheduling profile, and to output the modified scheduling profile display data to the display unit.

Known systems require a selection of a type of modification, and a separate entry of information pertaining to the extent of the modification. Even in its simplest form, there are at least two steps required by the user in order to modify the scheduling profile. Advantageously, a gesture-based apparatus such as that defined herein allows a user to input several pieces of useful input data with a single gesture. For example, the gesture data generating unit may be operable to categorise a gesture as a particular modifying action by its shape or direction and to measure its magnitude, and the modifying unit can then decide how and by what amount to modify the profile according to the category of gesture and the magnitude thereof. That is to say, the user does not need to specifically state what action they want to achieve as this is automatically implied by the gesture used. It may also obviate the need for a user to enter numbers by a keyboard, as the length of gesture can determine the value attributed to the action.

A scheduling profile includes a manufacturing schedule, in which numbers of units are scheduled to be manufactured in certain time periods in order to satisfy a demand such as that arising from a particular order or contract. Alternatively, a scheduling profile may be a schedule of actions such as transactions or payments from one party to another in exchange for temporary or permanent usage or ownership of an asset. A scheduling profile may contain information regarding the timing and magnitude of an action, for example, it could be a monthly repayment schedule, with each month having an associated repayment amount. Generally speaking, a scheduling profile is a series of actions which can be separated temporally and each allocated to a particular period in time.

The user interface unit may be, for example, a mouse, trackerball, touch pad, touchscreen, or a gyroscopic or accelerometer-based tracking device. Functionally, the user interface unit can be anything that is operably connectable to other units of the apparatus to produce a signal as a result of a gesture, which signal can be converted to input or tracking data to interact with a representation of a scheduling profile being displayed by the apparatus.

Depending on the particular embodiment, the user interface unit may be supported by a driver which turns a signal from the user interface unit into a form of data usable by the input data generating unit or other functional units and applications.

The gesture data generating unit is a functional unit which may include a processor (CPU), or may be operable to assign instructions to a processor, and may also include the functionality to access a lookup table when interpreting the tracking data. Functionally, the gesture data generating unit receives the tracking data from the user interface unit, and based on the tracking data and a set of processing rules, produces gesture data which acts as the basis of an instruction to the modifying unit.

The modifying unit is operable to receive gesture data from the gesture data generating unit and to update the scheduling profile accordingly. The modifying unit may store its own copy of the scheduling profile which is then output to the scheduling profile display data generating unit, or it may be able to make read and write requests to a stored version of the scheduling profile.

It will be understood by the skilled person that there are various modes of graphically representing a scheduling profile, and that the functional requirements of embodiments of the present invention are such that it may be preferable for each individual item in the profile (e.g. monthly payment or amount to manufacture) to be addressable via a gesture, so that a modification can be applied accordingly.

In known systems, the steps of selecting an action and then inputting a value for the action must be completed before the effect of the modification can be seen. This is disadvantageous, as it is often the case that changing a particular item of a scheduling profile, or moving a plurality of items, will have repercussive effects on other items. Alternatively, a modification made to the amount of an item may have an effect upon the temporal distribution of the items, or vice versa. In either case, a user of a prior art multi-stage input system may enter into an iterative trial and error process of repeatedly making modifications and having to undo those modifications or amend them in order to reach a desired state of the scheduling profile. Advantageously, in embodiments of the present invention the modifying unit is operable to modify the scheduling profile while the gesture is being made by the user. The modified scheduling profile can be displayed by the display unit while the gesture is being made, so that a feedback loop is established and the user can adapt the gesture before it is completed in order to ensure that the effect on the scheduling profile is as desired.

If the modifying unit is operable to modify the scheduling profile while the gesture is being made by the user, then the scheduling profile display data generating unit can send the modified data to the display unit, and the user can see in real time the impact of the gesture being made on the scheduling profile. This continual feedback mechanism enables the user to tailor the gesture being made based on live updates of the scheduling profile being displayed by the display unit. The user can then alter the gesture accordingly, for example, it may be that the user wanted to decrease the payment period for a loan, but did not want monthly payments to increase beyond a certain limit. If the gesture being made, at its most recent point, would have increased the monthly payments beyond that limit, this will be visible to the user via the display, and the user can alter the gesture accordingly, for example, by decreasing its extent to reduce the impact on the monthly payments.

The nature of the gestures being made by the user and the actions associated therewith in terms of how to modify the scheduling profile based on the action will vary depending on the embodiment. However, it has been found that a gesture-based apparatus such as the present invention lends itself very well to touchscreen technology. In such touchscreen embodiments, the display unit may be a touchscreen display functionally incorporating the user interface unit.

Advantageously, touchscreen technology lends itself to gesture based applications such as embodiments of the present invention, since the user can quickly make a series of gestures at disparate locations on the display without the delay caused by, for example, moving a mouse or trackerball cursor.

Advantageously, touchscreen embodiments are not restricted by the gesture having to made by an on-screen cursor. It is therefore possible to make more than one gesture concurrently, or to make a complex gesture involving two or more concurrent ‘touches’. In such embodiments, additional functionality can be realised through responding to more than one touch on the screen at a time. Preferably, the modifying unit is operable to modify the scheduling profile based on a plurality of independent concurrent streams of tracking data. Depending on the particular embodiment, or even on the locations and movement patterns defined by the tracking data associated with those touches, the apparatus may interpret the more than one concurrent touches as a single gesture or two or more separate gestures.

Optionally, the modifying unit is operable to generate gesture input data representing as a single gesture a plurality of independent concurrent streams of tracking data. Advantageously, the number and complexity of modifications that can be made through gestures is greatly increased by including the possibility of there being a plurality of tracking data streams contributing to a single set of gesture data. For example, whilst making a gesture to modify a particular item of the scheduling profile (repercussive effects on other items notwithstanding), it may be possible to make the same modification to other items by pressing the touchscreen in the appropriate area whilst making the gesture, thus indicating that the same modification should be made to those newly selected items, without necessarily having to make several individual gestures of the correct magnitude. In addition, it may be possible to select one or more scheduling profile items first, for example by tapping them, and then to make a single gesture to modify all selected scheduling profile items.

Of course, such gestures will be converted to gesture data from which the modification unit will decide on the modification to make to the scheduling profile. The modification unit may compare locations defined in the gesture data with the locations of various items in the scheduling profile as displayed. Preferably, the scheduling profile display data represents the scheduling profile as a series of spatially distinct areas, each area representing a time and an amount and being operable to change in response to the gesture being made on or in the vicinity of that area. Each area corresponds to at least one scheduling profile item.

Functionally, rather than a mere graphical representation of an item in the scheduling profile, each area may act as a button or active area whose location in relation to the location of the gesture of the user determines how the scheduling profile is modified. The areas may change according to a modification in the scheduling profile while a gesture is being made, for example, a gesture which shortens a payment period may increase the amount of other payments in a schedule, therefore causing them to increase in size. The categorisation of a gesture may be dependent upon whether its starting location coincided with an area representing a particular scheduling profile item, and which item that was. Alternatively, the categorisation of a gesture may depend upon a closest item to a particular point of the gesture, for example, the starting point, most recent point, or finishing point.

It may be the case that the modifying unit can modify the scheduling profile in a number of ways in response to a particular gesture. Therefore, some user input constraining the modifying unit's response to the gesture may be required, or some indication of the constraint used may be displayed. Optionally, when the modifying unit determines that modification of the scheduling profile may be constrained by a user input constraint, the scheduling profile display data generating unit may be operable to generate display data for the display unit to display a type and value of possible user input constraints. It may be that the user is able to select an option prior to making a gesture, or it may be it is on the basis of the gesture data that the modifying unit determines that user input is required. The value of the constraint may be alphanumerical, or it may be Boolean, for example, length of term can be varied=true/false. The constraint may apply to a single scheduling profile item or a group of scheduling profile items. Optionally, the display of the possible user input constraints is accompanied by an area allowing the user to vary the value or type of the constraints applied to the scheduling profile by the modification unit. For example, it might be that the user can make a gesture at the appropriate area to vary the value of a constraint, and can tap to toggle constraints on or off. Of course, it may be that selecting a particular constraint automatically deselects an alternative constraint, or vice-versa.

Optionally, a sum of each of the amounts represented by the areas of the scheduling profile is fixed to a predetermined value. That is, there may be a certain amount of money to be repaid in a schedule, or a certain amount of or number of a product to be manufactured. The modification unit will take this predetermined value into account as a constraint when modifying the scheduling profile. Alternatively, a sum of each of the amounts represented by the areas of the scheduling profile is calculated by the modifying unit according to an algorithm based on the time and amount represented by each of the areas. This may be the case when the scheduling profile is constrained by issues such as interest charges, taxes, or other factors which vary depending on the distribution and spread of amounts in a scheduling profile.

In another aspect of the invention, there is provided a method for modifying a scheduling profile according to a gesture of a user, the method comprising: at a scheduling profile display data generating unit, generating scheduling profile display data representing a scheduling profile; displaying the scheduling profile display data on a display unit; at a user interface unit, tracking the gesture of the user and providing tracking data; at a gesture data generating unit, generating gesture data representing the gesture of the user based on the tracking data; at a modifying unit, modifying the scheduling profile based on the gesture data; and at a scheduling profile display data generating unit, generating scheduling profile display data representing the modified scheduling profile, and outputting the modified scheduling profile display data for display by the display unit. The method may be a computer-implemented method.

In another aspect there is provided a computer program which, when executed by a computer, causes the computer to function as the apparatus of any of the apparatus embodiments or to perform the method of any of the method embodiments.

Preferred features of the present invention will now be described, purely by way of example, with reference to the following drawings, in which:

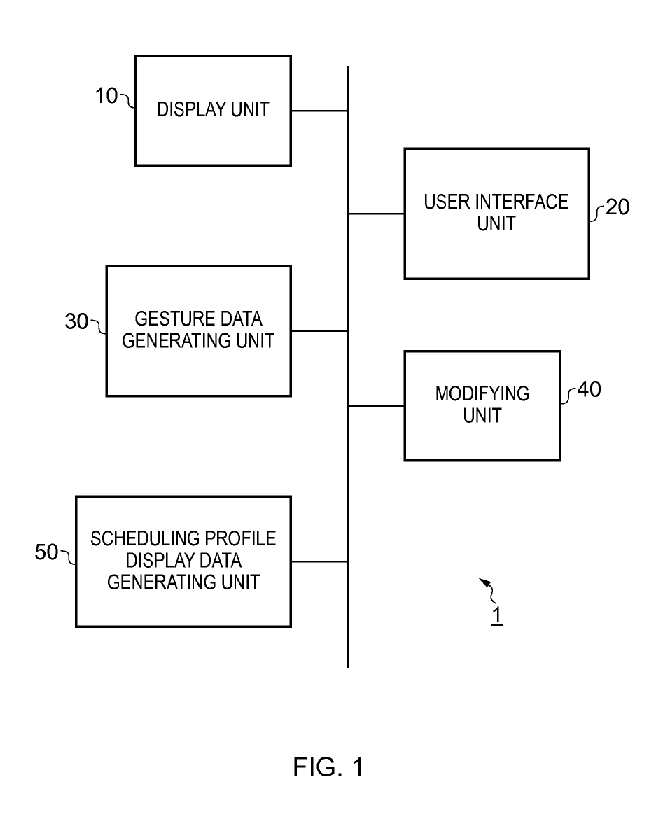

FIG. 1 is a schematic diagram of an apparatus embodying the present invention;

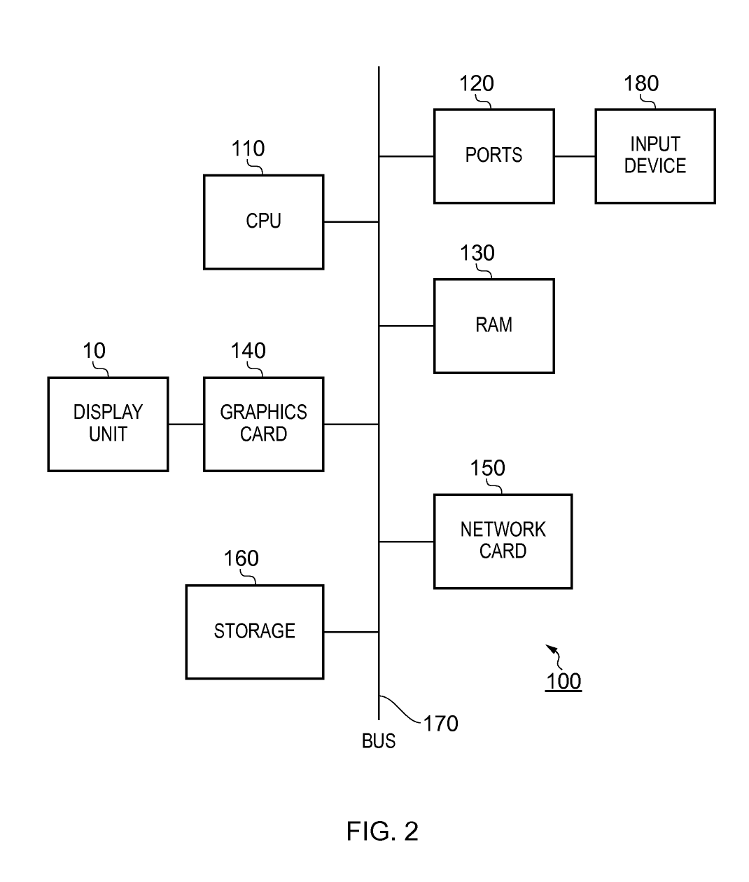

FIG. 2 is a schematic diagram of a computer which may be operable to function as an embodiment of the present invention;

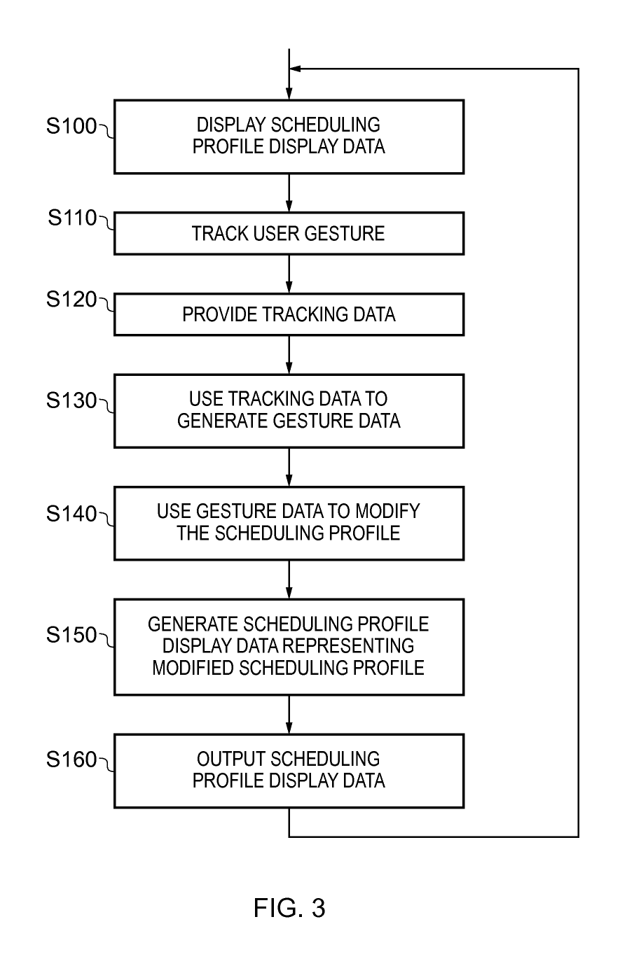

FIG. 3 is a flowchart representing a method embodying the present invention;

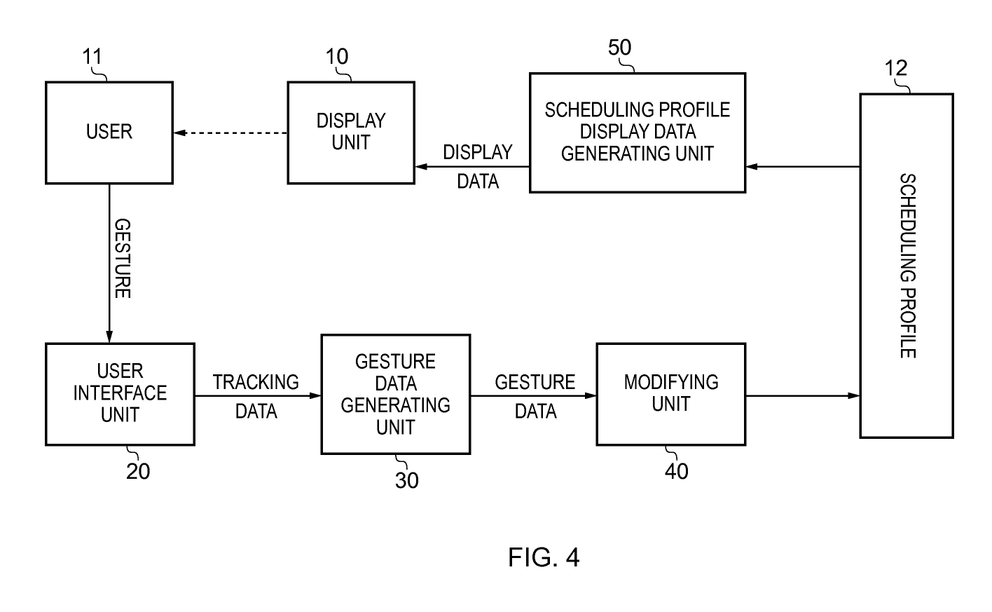

FIG. 4 is a functional representation of the flow of data and control between functional units and a user in embodiments of the present invention;

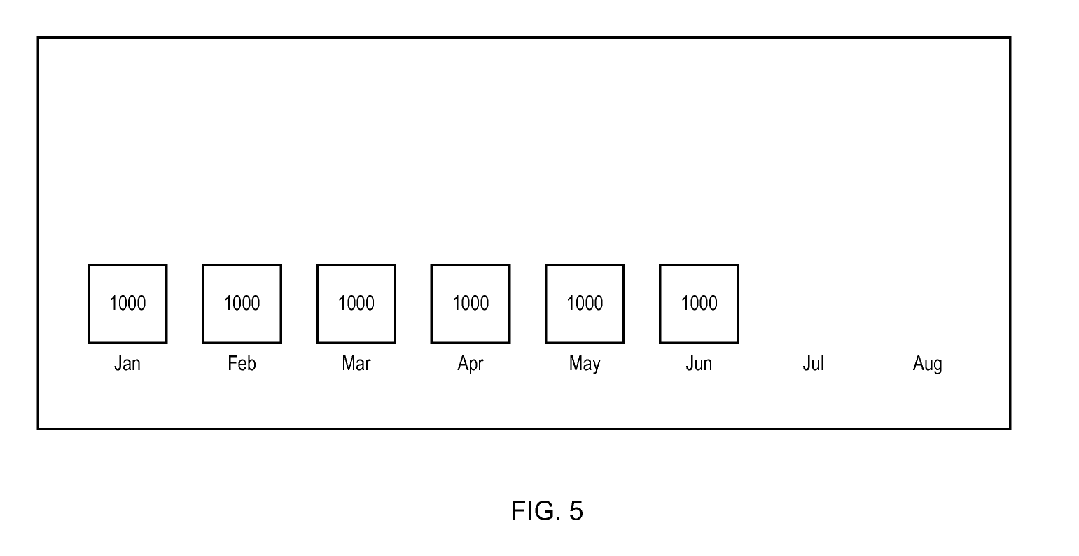

FIG. 5 illustrates a displayed unmodified scheduling profile according to an invention embodiment;

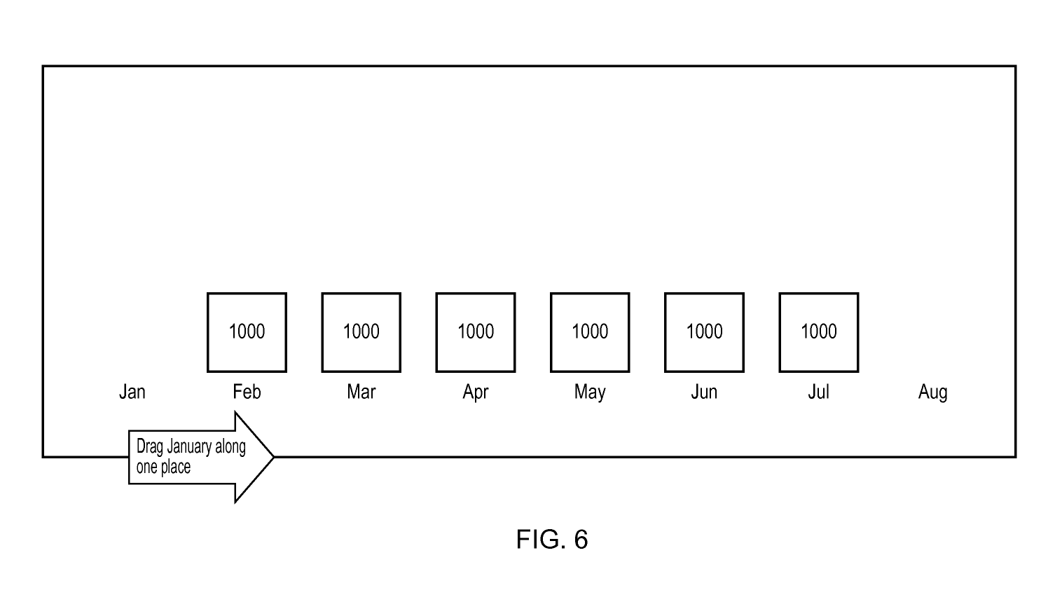

FIG. 6 illustrates the effect of a dragging gesture on the first scheduling profile item on the scheduling profile of FIG. 5;

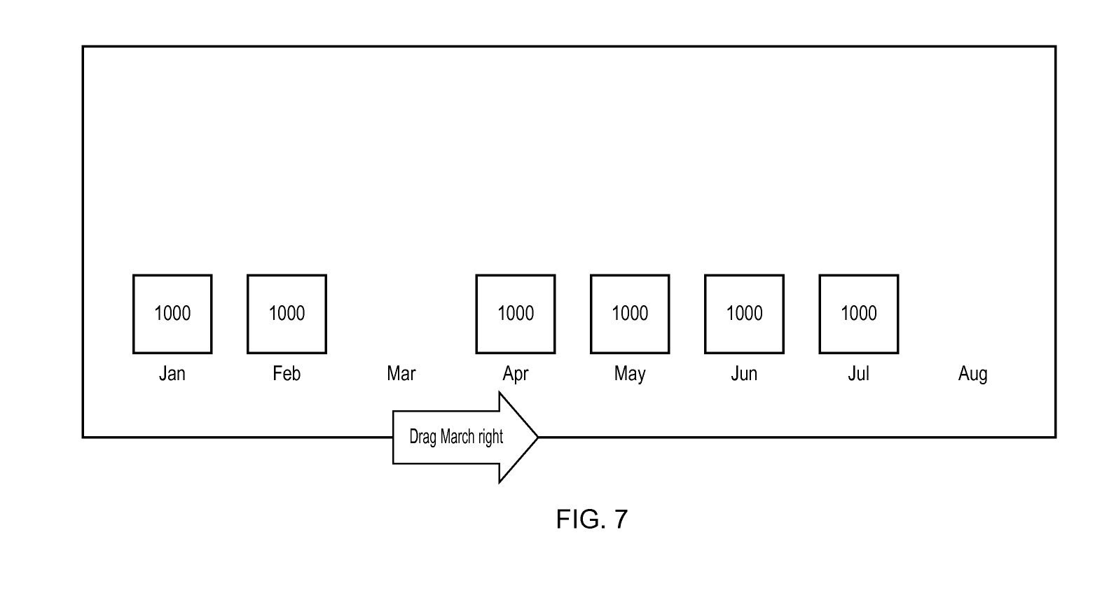

FIG. 7 illustrates the effect of a dragging gesture on a middle scheduling profile item on the scheduling profile of FIG. 5;

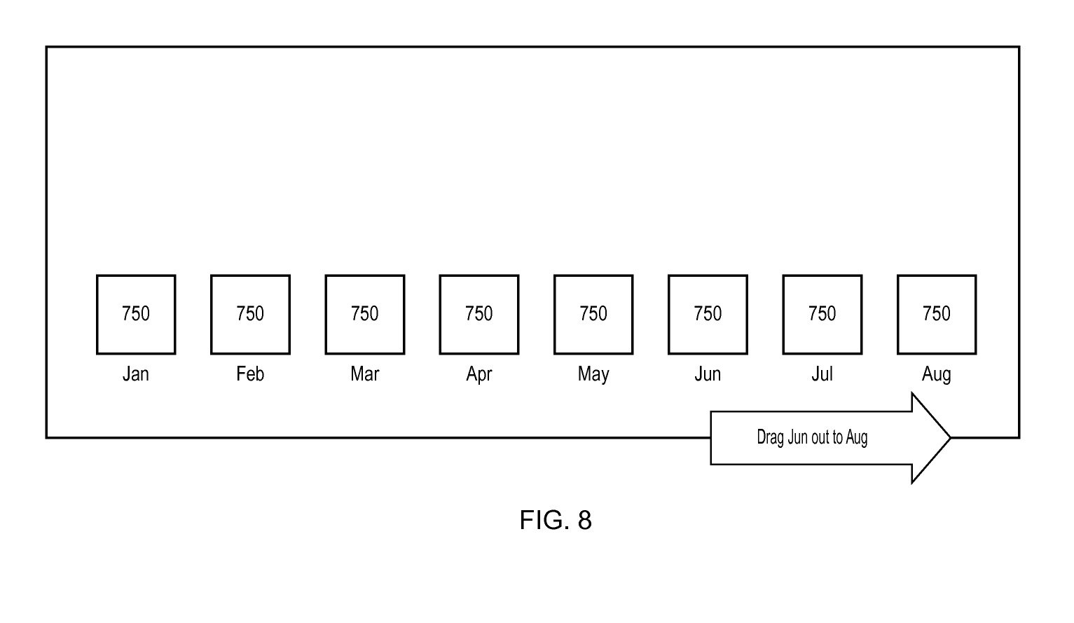

FIG. 8 illustrates the effect of a dragging gesture on the final scheduling profile item on the scheduling profile of FIG. 5;

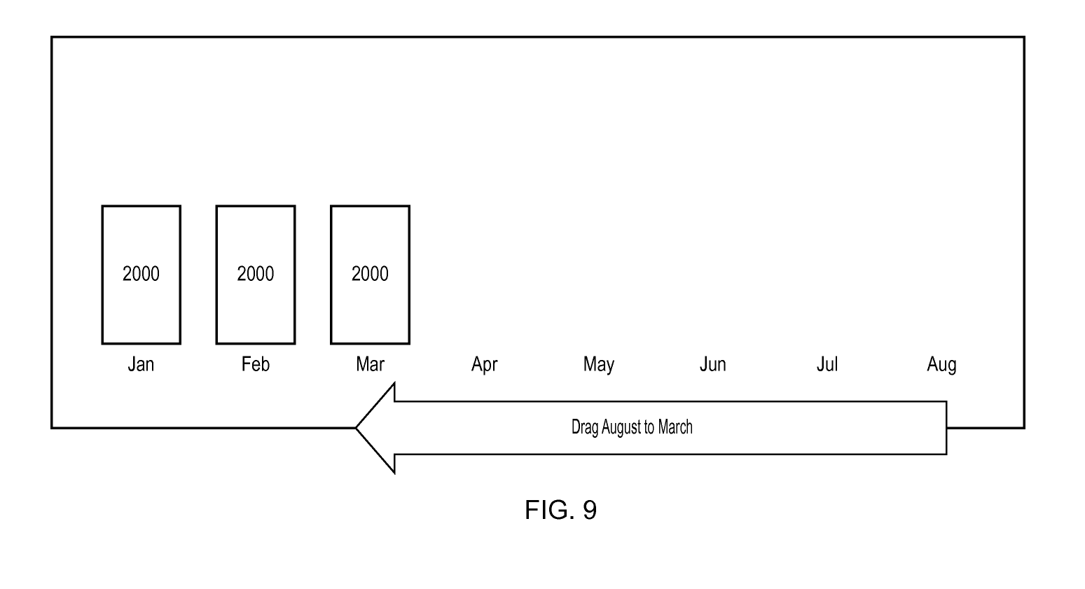

FIG. 9 illustrates the effect of a dragging gesture on the final scheduling profile item on the scheduling profile of FIG. 8;

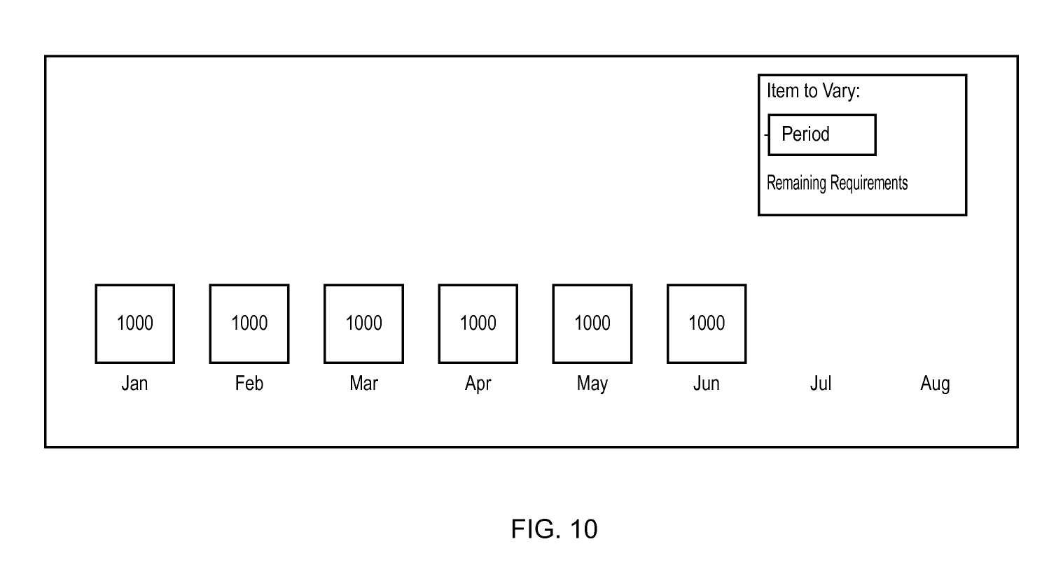

FIG. 10 illustrates an embodiment in which as well as displaying the scheduling profile, a dialogue box showing a constraint exercised by the modifying unit is also displayed;

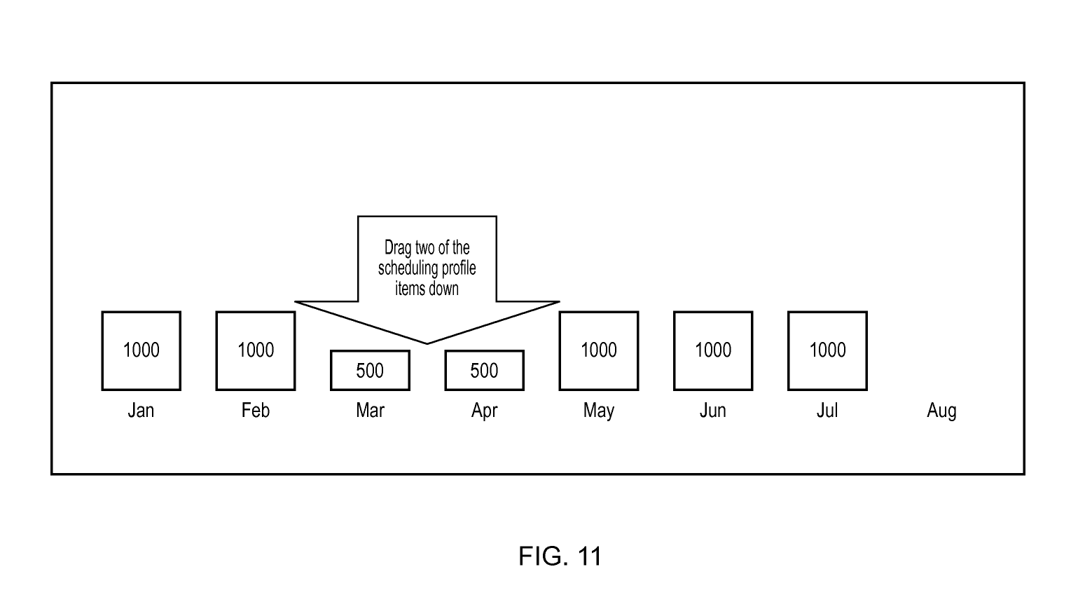

FIG. 11 shows how reducing the amount of one or more scheduling profile items can increase the term of the scheduling profile;

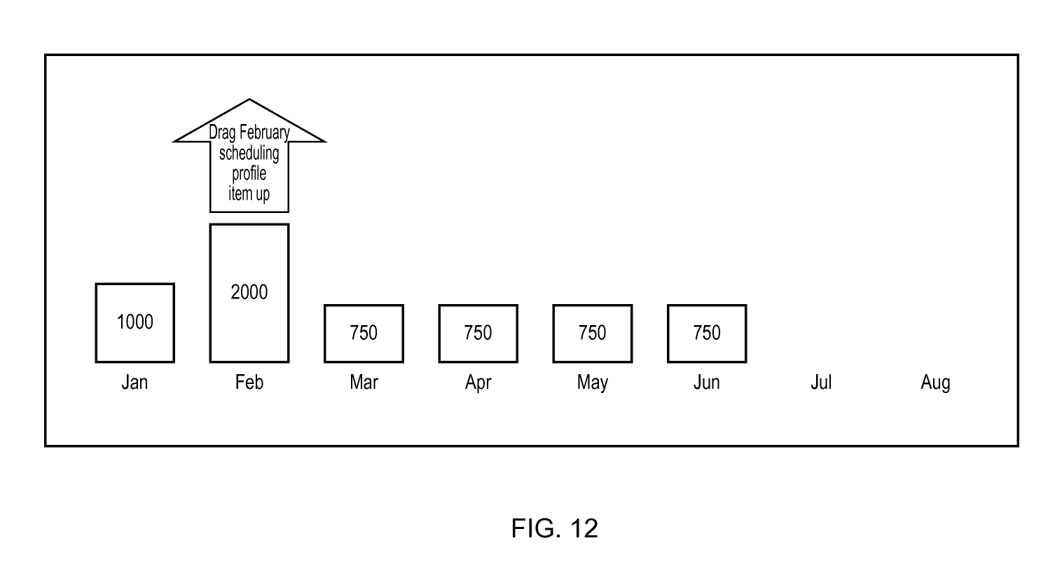

FIG. 12 illustrates an alternative to FIG. 11, in which reducing one or more scheduling profile items increases the amount of remaining items;

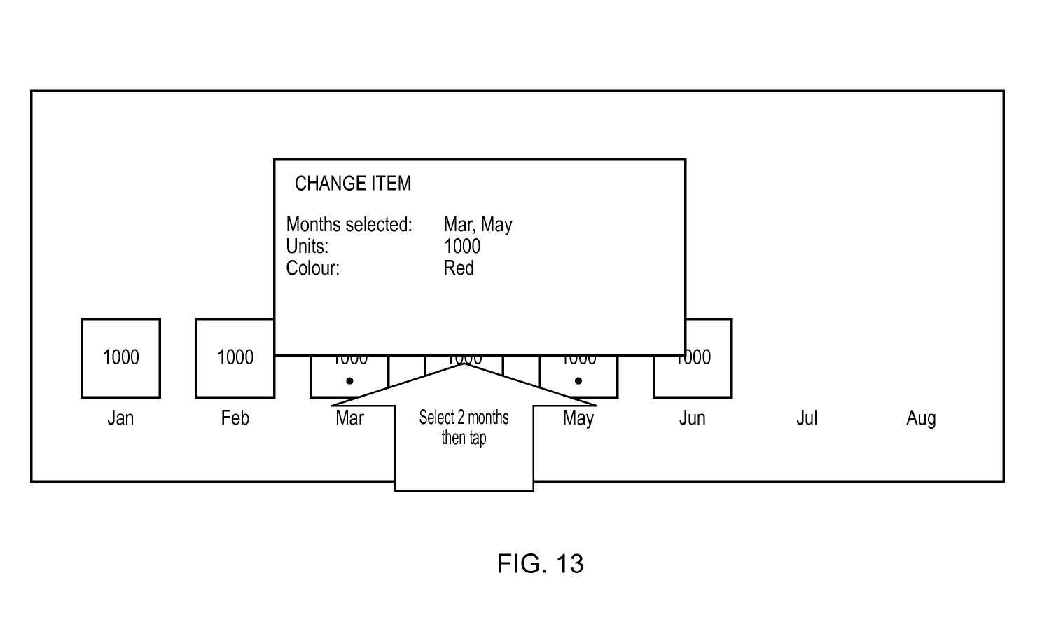

FIG. 13 illustrates the effect of a tapping gesture on a particular scheduling profile item;

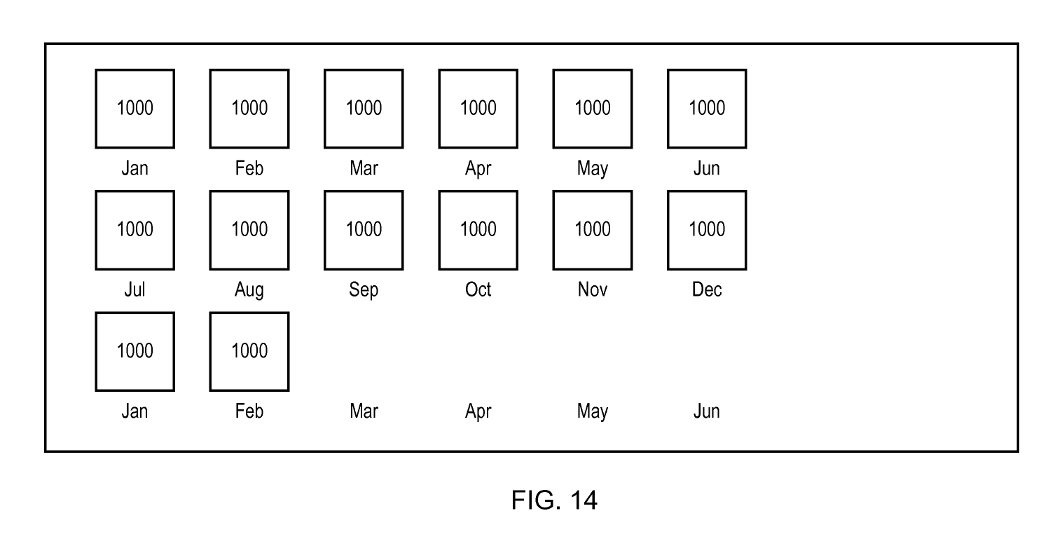

FIG. 14 illustrates a display option for a long term scheduling profile;

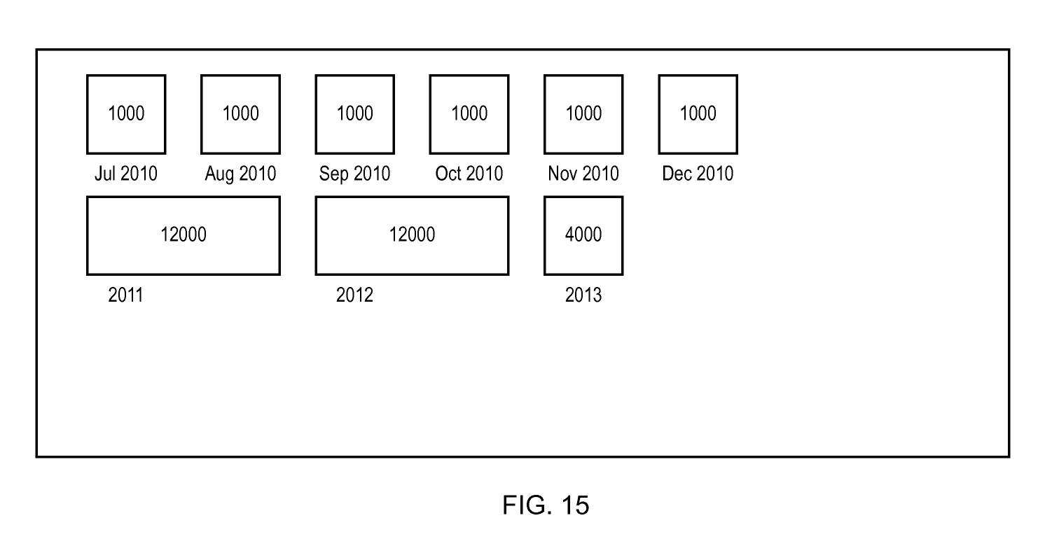

FIG. 15 illustrates an alternative display option for a long term scheduling profile;

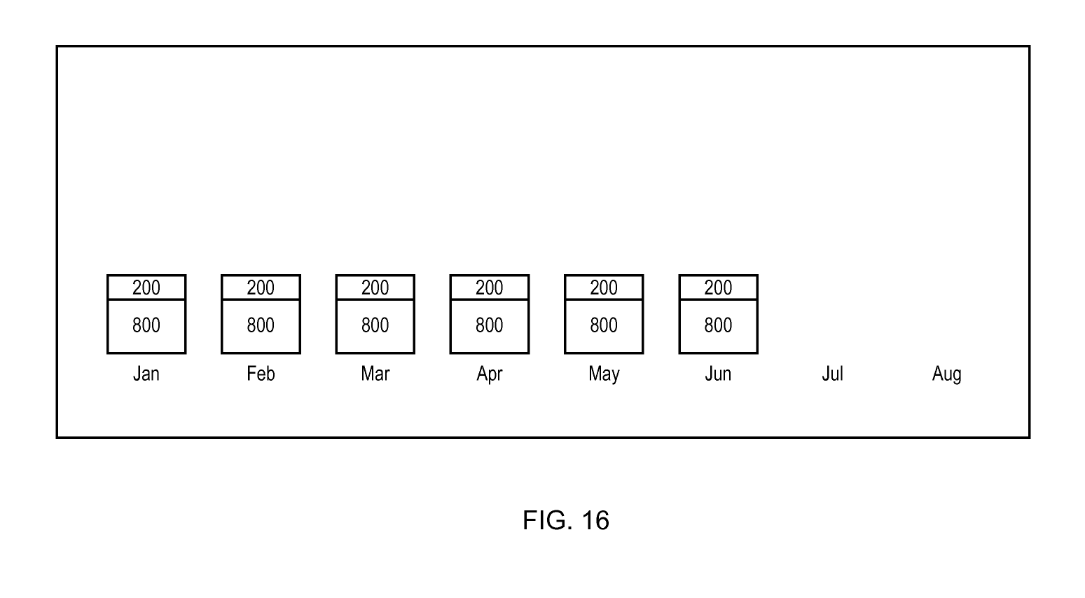

FIG. 16 is an illustration of a scheduling profile in which more complex information is represented in each scheduling profile item.

In FIG. 1 the display unit 10, user interface unit 20, gesture data generating unit 30, modifying unit 40, and scheduling profile display data generating unit 50 are interconnected and operable to exchange various forms of data with one another.

It should be understood that whilst the units have been illustrated as distinct units, they can be realised as any combination of elements able to perform the function attributed to that unit. For example, the user interface unit 20 may be a user-held input device such as a mouse, or a touch screen, and may also include firmware, middleware, and software elements in order to provide tracking data to the gesture data generating unit 30. In this way, the user interface unit 20 as a functional unit may include some processing functionality, so that the user interface unit 20 is an input device and driver code run on a computing device having a processor.

For example, the apparatus may be realised as a computer which also runs other applications or performs other functions which utilise data from the input device. The driver may be considered to be part of the user interface unit 20 itself, or may be considered to be a separate functional unit, again, this depends on the particular embodiment. The output of the user interface unit 20 is tracking data which is then output to and interpreted by the gesture data generating unit 30. The tracking data effectively maps the gesture onto the image being displayed by the display unit so that each point of the gesture has a corresponding location within the image of the display unit. The tracking data may include additional information such as whether and when particular buttons were depressed.

Similarly, the gesture data generating unit 30 is operable to take data of one form, the tracking data provided by the user interface unit 20, and to convert the received tracking data into gesture data for output to a modifying unit 40. The gesture data generating unit 30 may be realised as software code executing processing rules in conjunction with a processor and possibly accessing lookup tables stored on a storage device or in some other memory. It may be that the gesture data is generated and output to the modifying unit 40 at set time intervals, so that many iterations of gesture data representing a single gesture are output to the modifying unit 40. For example, data representing the most recent location on the display corresponding to the most recent point of the gesture may be updated in each iteration. The gesture data generating unit 30 is operable to output gesture data to the modifying unit 40. The gesture data generating unit 30 may be able to perform its function whilst the gesture is being made, so that the tracking data of the gesture so far are used to produce gesture data for the gesture so far. The gesture data generating unit 30 may be operable to receive additional information, such as whether a certain user operating button was depressed at the time when tracking data was generated. For example, gesture data may only be generated for tracking data generated whilst a particular button was depressed. Alternatively, for example in an apparatus having a touchscreen user interface unit 20, it may be that tracking data is only generated when a user is in contact with the touchscreen, and so gesture data is generated for substantially all tracking data.

The gesture data generating unit 30 may codify the tracking data into a simplified set of parameters representing the gesture. For example, the shape of a gesture may be defined by the starting point and the most recent point of a gesture only, with the route taken between the two points being immaterial. Therefore, the gesture data may simply be a starting point and most recent point of a gesture. Additional data items such as a gesture ID, a categorisation of the gesture, and whether or when a particular button was depressed may also be included. Gesture ID may be used to distinguish one gesture from another, whether the gestures are concurrent or otherwise. In some embodiments, it may be that gesture data can only be generated whilst a particular button is depressed, in which case data generated otherwise may not be included in the gesture data. However, in other embodiments it may that, for example, a mouse click or some other signal is used to denote the start or end of a gesture.

Gestures may be categorised depending on, for example, the angle defined by a line joining the starting location and the most recent location. An angle closer to vertical than horizontal may be categorised as a vertical gesture and vice versa. In cases such as these, it may be that most recent location is not required in categorising the gesture, for example, the gesture could be parameterised with a starting location, a gesture ID, a category (eg vertical), and a vertical displacement of the most recent location with respect to the starting location. The gesture categorisation may be decided upon by the initial portion of a gesture, that portion being configurable according to embodiments.

The gesture data generating unit 30 can begin outputting gesture data to the modifying unit 40 as soon as tracking data has been received and converted to gesture data. However, it may be that the conversion to gesture data can only occur once the gesture has either terminated, or exceeded a minimum spatial extent. Or it may be that a gesture not exceeding a minimum spatial extent is categorised as a ‘tap’.

The modifying unit 40 should also have some processing capability and must also have access to the storage or memory device holding a latest modified version of the scheduling profile in order that the scheduling profile can be modified in accordance with the received gesture data. Again, the modifying unit 40 may be realised as software executing processing rules, and it may output, for example, modified sections of a scheduling profile to replace existing sections, or it may execute modifying processes on a version of the scheduling profile and rewrite the storage area holding the latest modified version with the newly modified version. The modifying unit 40 may be operable to refresh the scheduling profile at set time intervals, as it is desirable to modify the scheduling profile while a gesture is being made, in order that the rest of the gesture can be informed by the impact of the gesture so far on the scheduling profile, the changes being displayed via the display unit.

The location of the gesture in terms of its gesture data in relation to the representation of the scheduling profile being displayed by the display unit at various times during the gesture is taken into account in deciding how to modify the scheduling profile. The modification may include inserting a gap between two items in the profile as a ‘holiday’, altering the size of one item in the profile in relation to the others, lengthening or shortening the temporal spread of items in the profile, or other functions, depending on the complexity of the embodiment. In some embodiments, a modification to a particular item in the profile will have repercussions in other items in the profile.

The visual representation of the scheduling profile seen by the user on the display unit is dictated by the scheduling profile display data generated and output by the scheduling profile display data generating unit 50. There may be user configurable options and preferences which affect the form of the representation of the scheduling profile output for display on the display unit. It may be that the modifying unit 40 is operable to modify the scheduling profile at set intervals, and that therefore the scheduling profile display data generating unit 50 generates and outputs display data to the display unit at the same rate. Outputting display data to the display unit may be via a bus connection and graphics card, depending on the particular embodiment.

The display unit 10 is operable to display the representation of the scheduling profile output by the scheduling profile display generating unit. The display unit may include a graphics card, depending on the particular embodiment. Alternatively, the graphics card may be considered to be a separate component.

The display unit 10 may be a touchscreen combining with the user interface unit 20. Such embodiments may be able to handle gestures involving a plurality of streams of tracking data, or be able to handle multiple concurrent gestures. For example, using more than one finger at a time, there may be more than one contact point between the user and the touchscreen so that two or more independent streams of tracking data are provided to the gesture data generating unit 30 by the user interface unit 20. The streams of data may be distinguished from one another by, for example, a stream ID. Each stream of tracking data may give rise to its own gesture data, so that the modifying unit 40 is receiving gesture data for two gestures concurrently. It may be possible to modify the scheduling profile based on the two sets of gesture data. For example, it may be possible to make a gesture delaying the first of a series of items in a scheduling profile whilst also bringing forward the final action of that profile.

Alternatively, it may be that the gesture data generating unit 30 takes the two or more concurrent streams of tracking data and makes a single set of gesture data, for example, a ‘pinch’ gesture. In this case, the gesture may be categorised according to how many streams of tracking data are being received concurrently, and the characteristics of each stream.

FIG. 2 is a schematic representation outlining a hardware configuration of a computing device 100 that may be included as hardware in an embodiment of the present invention, with further functionality provided by further hardware and software. Alternatively, the embodiment may be a computer program can be loaded onto and executed by a computer with a hardware configuration such as that illustrated.

In the computing device 100 depicted, the ports 120, CPU 110, RAM 130, graphics card 140, network card 150, and storage 160 are interconnected via a BUS connection 170. The graphics card 140 functions as an interface to the display unit 10. The ports 120 function as an interface or interfaces to one or more input devices 180. In some embodiments, the input device and display screen may be realised as a single touchscreen unit, hence it should be appreciated that the separation of the input device 180 and display unit 10 in the computing device 100 represent functional separation, and that a single device or component may function as more than one of the constituent elements.

FIG. 3 is a flow chart illustrating a method embodying the present invention. Step S100 is a step of displaying scheduling profile display data. This enables the user to see an image representing the scheduling profile. It is not only the user's gesture but the location of the gesture, or the tracking data representing the location of the gesture, in relation to various interactive sections of the image representing the scheduling profile that influence the type of modification carried out as a result of the gesture and the extent of the modification.

At step S110 the user's gesture is tracked. This tracking, for example with a mouse or touchscreen, provides a means by which a gesture of a user can be converted into data for use by an apparatus embodying the present invention, for example a computer, to then provide tracking data at step S120. The tracking data provides data which maps the user gesture onto locations within the representation of the scheduling profile displayed by the display unit, for example by using a common coordinate system.

At step S130 the tracking data is used to generate gesture data which codifies and simplifies the tracking data, which may be a long series of coordinates (stream), into gesture data containing only key pieces of data representing the gesture which can then be used to modify the scheduling profile. The generation of gesture data in S130 may include categorising the gesture based on the tracking data and allocating an action to the gesture accordingly.

At step S140 the gesture data is used to modify the scheduling profile. Modifying the scheduling profile includes comparing the gesture data with certain interactive areas of the image of the scheduling profile being displayed and modifying the scheduling profile accordingly. The modifying unit 40 responsible for modifying the scheduling profile may need access to the most recently displayed version of the scheduling profile for comparison with the gesture data to carry out the modification. Alternatively, it may be the location of certain interactive areas on the image of the scheduling profile at the beginning of the gesture that dictate how the scheduling profile should be modified.

At step S150 scheduling profile display data representing the modified scheduling profile is generated. The modifications to the scheduling profile, which may have been, for example, a decrease in size of one scheduling item leading to a repercussive increase in size of other scheduling items, are made visible to the user via the display unit. There may be a set of configurable user preferences which also influence the form in which the scheduling profile is displayed to the user.

At step S160 the scheduling profile display data is output to the display unit.

FIG. 4 is a schematic diagram representing the flow of data in various forms in embodiments of the present invention, and emphasises the feedback loop enabled by embodiments of the present invention, with the impact on the scheduling profile of a gesture being made visible to the user whilst the gesture is being made.

The user 11 makes a gesture, which interacts with the user interface unit 20 either via a touchscreen or via some physical motion caused to an input device such as a mouse or some other input means.

On the basis of the interaction with the gesture, the user interface unit 20 is operable to generate tracking data and is then operable to output the tracking data to the gesture data generating unit 30.

On the basis of the received tracking data, the gesture data generating unit 30 is operable to generate gesture data, and then to output the gesture data to the modifying unit 40.

On the basis of the received gesture data, the modifying unit 40 is operable to modify the scheduling profile, for example by performing memory access read and write operations to modify the stored scheduling profile 12. The scheduling profile 12 may be stored among a plurality of scheduling profiles in a scheduling profile database in a storage unit, and selected for modification by the user by, for example, utilising a search function.

The scheduling profile display data generating unit 50 is operable to generate display data representing the modified scheduling profile 12, and then to output the modified display data to the display unit 10.

The display unit 10 is then operable to display the representation of the modified display data. The user can see the representation of the modified scheduling profile on the display unit 10, and while the gesture is incomplete, may wish to alter the gesture accordingly.

A gesture may be deemed to be complete, for example, when contact with a touchscreen is discontinued, or when a mouse button ceases to be depressed. In some embodiments, completion of a gesture may prompt a dialogue box being displayed to present the user with the option to accept or reject the modifications made as a result of the most recently completed gesture.

Some sample gestures on a touchscreen embodiment and their resultant modifications will now be described in detail. It will be appreciated that these are merely exemplary, and many more options exist for how particular gestures could modify a scheduling profile. Two embodiments will be discussed, a first principal embodiment in which the scheduling profile is for manufacturing requirements and each scheduling profile item represents a quantity of units to be manufactured in a given time period, and an alternative embodiment in which the scheduling profile is a repayment schedule and each scheduling profile item represents a repayment amount to be made in a given time period.

FIG. 5 illustrates an unmodified scheduling profile as selected to view by a user. The illustrated scheduling profile represents monthly manufacturing requirements, for example to satisfy an order or contract for a particular customer. The illustrated scheduling profile represents six monthly requirements of 1000 units for a contract for a total of 6000 units. The unmodified scheduling items, the individual monthly requirements, are shown as squares.

In the alternative embodiment in which the scheduling profile is a schedule for asset repayments, the illustrated scheduling profile represents six monthly repayments of £1000 for an asset having an agreed repayment price of £6000. The unmodified scheduling items, the individual repayments, are shown as squares.

FIG. 6 illustrates the effect of a dragging gesture. In a touchscreen embodiment, the user begins with a finger on the area representing the January repayment, and drags the finger, whilst contacting the touchscreen, to the right until approximately aligned with the text ‘Feb’, representing the month of February. In this embodiment, it is notable that the scheduling items move in relation to locations on the screen representing times or dates. The scheduling profile is modified to reflect a delay in the start of manufacturing by making the dragging gesture. As illustrated, the manufacturing is still spread over 6 months, but now begins in February and ends in July.

In the alternative embodiment, the effect of the same gesture would be to indicate a delay in the commencement of repayments.

FIG. 7 also illustrates the effect of a dragging gesture on the scheduling profile illustrated in FIG. 5. In FIG. 7, the gesture is a dragging gesture from the item originally aligned with Mar, representing the March repayment, to the right, ending approximately aligned with Apr, representing the April repayment. The modification resulting from this gesture is to automatically extend the manufacturing period, so that it is now spread between January and July, and to insert a manufacturing holiday during March (for example, due to no demand from the customer or due to a factory shutdown). The further the gesture is extended to the right, the longer the manufacturing holiday.

In the alternative embodiment, the effect of the same gesture would be to indicate on the scheduling profile an extension of the repayment period, and a payment holiday during March. Again, the further the gesture is extended to the right, the longer the payment holiday.

The same result may be achieved by a dragging gesture made in an intermediate space between two scheduling items. For example, the second manufacturing requirement of 1000 units was originally scheduled for February, and the third for March (see FIG. 5). A vertical dragging gesture beginning in the space between the box representing the February requirement and the box representing the March requirement could have the same modifying effect on the scheduling profile as the rightward gesture illustrated on FIG. 7. Again, the same gesture would have an equivalent result in the alternative embodiment.

FIG. 8 illustrates the effect of a dragging gesture on the scheduling profile illustrated in FIG. 5. In the case of FIG. 8, the dragging gesture originates on or around the scheduling profile item representing the final requirement. The gesture is a dragging gesture to the right, and terminates at or around the ‘Aug’ label, representing the month of August. The effect of the gesture is to extend the manufacturing period by 2 months and to automatically reduce the monthly manufacturing requirements in real time, so that each month's requirement is now ⅛^{th} of the total amount rather than ⅙^{th}. That is to say, the total number of units to be manufactured as represented by the scheduling profile remains constant. The height of each item reduces proportionally.

In the alternative embodiment, the effect of the gesture is to extend the payment term by 2 months and to automatically reduce the individual repayment amounts proportionally in real time, so that each month's repayment is now ⅛^{th} of the total amount rather than ⅙^{th}. The total amount of money to be repaid remains constant. The height of each item reduces proportionally.

FIG. 9 illustrates the effect of an alternative dragging gesture on the scheduling profile illustrated in FIG. 8. In the case of FIG. 8, the dragging gesture originated on or around the scheduling profile item representing the final monthly manufacturing requirement. In this case, the dragging gesture originates in the final monthly manufacturing requirement resulting from the modifications made by the gesture of FIG. 8, namely August. In the case of FIG. 9, the gesture is a dragging gesture to the left, and terminates at or around the ‘Mar’ label. The effect of the gesture is to reduce the manufacturing period of the units by 5 months and therefore to automatically increase in real time the amount of units to be manufactured each month, so that each month's requirement is now ⅓^{rd} of the total number of units rather than ⅛^{th}. That is to say, the total number of units to be manufactured represented by the scheduling profile remains constant. The height of each item increases proportionally.

In the alternative embodiment, the effect of the gesture is to reduce the term of the repayments by 5 months and therefore to automatically increase in real time the value of each repayment. Again, each repayment is now ⅓^{rd} of the total amount to repay rather than ⅛^{th}. The total value of the repayments represented by the scheduling profile remains constant and the height of each particular scheduling profile item varies in proportion with the value of the individual repayment it represents.

It is also possible that a single gesture was made, with the user continuously in contact with the touchscreen and dragging originally rightward on the June item of the scheduling profile illustrated by FIG. 5. As a result of the rightward dragging, the scheduling profile may have been modified while the gesture was still being made, thus resulting in the display illustrated in FIG. 8. The user may then have dragged from August back to March, thus resulting in the scheduling profile illustrated in FIG. 9. Of course, there may have been displayed various other intermediate states of the scheduling profile.

FIG. 10 shows the scheduling profile displayed as in FIG. 5, but the display includes an additional dialogue box 14 with a selection of items to vary. In the embodiment pictured there are two options for items to vary: ‘Period’ or ‘Remaining Requirements’. The user can select between these options by touching the screen at the location of the option text. The dialogue box 14 may appear in advance of a gesture being made, so that the modifying unit 40 can use the chosen option as a constraint when modifying the scheduling profile. Optionally, it may be that the apparatus is able to recognise when the modification to make in response to a gesture is ambiguous, and can bring the dialogue box up during the gesture or after the gesture has been completed. Alternatively, the dialogue box may be displayed with the default option selected, and the modifications carried out on the basis of the default option. The user can then touch the screen on the other option to change the constraints of the modifications and hence the modifications will be recalculated and the display updated accordingly.

In the alternative embodiment, the options for items to vary may be ‘Term’ and ‘Remaining Repayments’.

For example, in FIG. 11, a gesture is made to modify a scheduling profile as displayed in FIG. 5. The gesture is to reduce two of the monthly requirements, those due in March and April. This may be achieved by touching the screen in two places at once, both over the item for March, and the item for April, and dragging down. The extent of reduction may be set to be the same for both items when two are reduced by substantially simultaneous gestures. Alternatively, it may be possible to first select the March and April monthly requirement items by simply touching them, and then making a single downward dragging gesture from a location above the two items. It may be that selecting scheduling profile items in this way causes them to be highlighted in some way on the display unit. Bearing in mind the constraint that the total number of items to be manufactured is fixed, in response to this gesture, the modification unit could either increase the number of items in the remaining months, or increase the manufacturing period by a month. As discussed previously in relation to the dialogue box 14 on FIG. 9, a dialogue box will appear at an appropriate time to allow an option to be taken regarding the mode of modification. In the example of FIG. 11, the term is varied, which is consistent with the selected option in the dialogue box 14 of FIG. 10.

In the alternative embodiment, the effect of the gesture could be to either increase the value of repayments in the remaining months after April, or to increase the repayment term by a month. As before, the user's selection on the dialogue box will dictate which of the modifications is effected.

FIG. 12 illustrates a case in which a dialogue box 14 has been displayed (not shown in this Figure), and the option ‘Remaining Requirements’ has been selected. The modifying unit 40 will therefore modify the amount represented by the scheduling profile items chronologically following the item forming the subject of the gesture. In the example of FIG. 12, the scheduling profile was originally as displayed in FIG. 5. The user gesture was an upwards dragging originating on or around the item representing the February requirement, which resulted in an increase in the number of units to be manufactured in that month, and hence a proportional increase in the area of the February scheduling profile item. Exercising the constraint that the total number of units to be manufactured is fixed, and the chosen option to vary the remaining monthly requirements rather than the manufacturing period, the modifying unit 40 responds to the gesture by reducing the subsequent requirements by an equal number, and the scheduling profile display data generating unit 50 alters the size of the scheduling profile items accordingly.

In the alternative embodiment, the effect in the example of FIG. 12 would be to increase the value of the repayments scheduled for February. The chosen option to vary was ‘Remaining Repayments’, and the constraint regarding the fixed total repayment amount still applies, hence the modifying unit 40 responds to the gesture by reducing the value of the payments in March to June by an equal amount, and the scheduling profile display data generating unit 50 alters the size of the scheduling profile items accordingly.

FIG. 13 illustrates an operation of modifying details of a particular scheduling profile item or group of scheduling profile items by a tapping gesture on the items. In the manufacturing schedule example, tapping a box representing a particular month's manufacturing requirement brings up a detail configuration box 15 where its details can be changed, for example, by further gestures. It is also possible to select several scheduling profile items as a group or set of individual items to change the group or set together. For example, the details may relate directly to the scheduling, such as the number of units to be manufactured, may relate to details of the units, such as colour, or may relate to other aspects of the order such as delivery details or customer details.

In the alternative embodiment, the details displayed in the detail configuration box 15 may relate to information such as payment method.

The scheduling profile display data generating unit 50 outputs display data to the display unit. The form in which a scheduling profile is displayed will depend on many variables, such as the display size, the nature of the scheduling profile, the length of time represented by the scheduling profile, user configurable options regarding display form, and others. In the example shown in FIG. 14, the total manufacturing requirement is higher than in FIGS. 5-13, and the monthly requirements are spread over a longer manufacturing period. In the particular display shown in FIG. 14, the scheduling profile items are displayed as a grid.

Again, in the alternative embodiment the example shown in FIG. 14 represents a larger total repayment amount than in FIGS. 5-13 and the repayments are spread over a number of years.

FIG. 15 illustrates another form of displaying a scheduling profile with items spanning a number of years. On FIG. 15, the scheduling profile is for a manufacturing plan with particular requirements each month from July 2010 until April 2013. However, only the remaining months of the current year are shown as individual areas on the display. The years 2011, 2012, and 2013, are each represented by an area which acts as the scheduling profile items discussed in previous examples, however, changes made to the year may affect all twelve individual monthly requirements in that year. It is possible to mix and match groupings as required. For example, the groupings may be collapsible via a double tap gesture on the year scheduling profile item.

Again, in the alternative embodiment the display in FIG. 15 represents a larger total repayment amount than in the previous examples and the repayments are spread from July 2010 until 2013.

FIG. 16 is an illustration of how more complex information can be included in the displayed representation of individual scheduling profiling items. In the example shown, the scheduling profile is a manufacturing plan for a complex product comprising more than one constituent ingredient, for example cement. Horizontal bandings represent separate constituent ingredients, though more than one ingredient may be grouped and displayed in a single band. The amount of each ingredient or constituent product may also be displayed. In the example shown in FIG. 16, each monthly manufacturing requirement includes 800 units of one constituent product and 200 of another.

In the alternative embodiment, the repayment plan, each repayment may consist of several different parts: capital repayment, interest, tax, insurance, and possibly other contributions. Horizontal bandings separate different contributory amounts, though several contributions may be grouped and displayed in the same band. The value attributed to that contribution or group of contributions is also displayed. In the example illustrated in FIG. 16, each repayment consists of £800 capital repayment and £200 interest.

In any of the above aspects, the various features may be implemented in hardware, or as software modules running on one or more processors. Features of one aspect may be applied to any of the other aspects.

The invention also provides a computer program or a computer program product for carrying out any of the methods described herein, and a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

1. Apparatus arranged to modify a scheduling profile according to a gesture of a user, the apparatus comprising:
a display unit for displaying scheduling profile display data;
a scheduling profile display data generating unit for generating scheduling profile display data representing the scheduling profile, and outputting the scheduling profile display data to the display unit;
a user interface unit for tracking the gesture of the user and providing tracking data;
a gesture data generating unit for generating gesture data representing the gesture of the user based on the tracking data; and
a modifying unit for modifying the scheduling profile based on the gesture data; wherein
the scheduling profile display data generating unit is also operable to generate scheduling profile display data representing the modified scheduling profile, and to output the modified scheduling profile display data to the display unit.

2. The apparatus according to claim 1, wherein
the scheduling profile includes a plurality of individual items, each of which are addressable by a gesture of the user.

3. The apparatus according to claim 1, wherein
the modifying unit is operable to modify the scheduling profile while the gesture is being made by the user.

4. The apparatus according to claim 1, wherein
the display unit is a touchscreen display functionally incorporating the user interface unit.

5. The apparatus according to claim 4, wherein
the modifying unit is operable to modify the scheduling profile based on a plurality of independent concurrent streams of tracking data.

6. The apparatus according to claim 5, wherein
the modifying unit is operable to generate gesture input data representing as a single gesture a plurality of independent concurrent streams of tracking data.

7. The apparatus according to claim 1, wherein
the scheduling profile display data is operable to represent the scheduling profile as a series of spatially distinct areas, each area representing a time and an amount and being operable to change in response to the gesture being made on or in the vicinity of that area.

8. The apparatus according to claim 7, wherein
a sum of each of the amounts represented by the areas of the scheduling profile is fixed to a predetermined value.

9. The apparatus according to claim 7, wherein
a sum of each of the amounts represented by the areas of the scheduling profile is calculated by the modifying unit according to an algorithm based on the time and amount represented by each of the areas.

10. The apparatus according to claim 1, wherein
when the modifying unit determines that modification of the scheduling profile may be constrained by a user input constraint, the scheduling profile display data generating unit is operable to generate display data for the display unit to display a type and value of possible user input constraints.

11. The apparatus according to claim 10, wherein
the display of the possible user input constraints is accompanied by an area allowing the user to vary the value or type of the constraints applied to the scheduling profile by the modification unit.

12. A method for modifying a scheduling profile according to a gesture of a user, the method comprising:
at a scheduling profile display data generating unit, generating scheduling profile display data representing a scheduling profile;
displaying the scheduling profile display data on a display unit;
at a user interface unit, tracking the gesture of the user and providing tracking data;
at a gesture data generating unit, generating gesture data representing the gesture of the user based on the tracking data;
at a modifying unit, modifying the scheduling profile based on the gesture data; and
at a scheduling profile display data generating unit, generating scheduling profile display data representing the modified scheduling profile, and outputting the modified scheduling profile display data for display by the display unit.

13. A non-transitory storage medium storing a computer program which, when executed by a computer, causes the computer to perform a method comprising:
at a scheduling profile display data generating unit, generating scheduling profile display data representing a scheduling profile;
displaying the scheduling profile display data on a display unit;
at a user interface unit, tracking the gesture of the user and providing tracking data;
at a gesture data generating unit, generating gesture data representing the gesture of the user based on the tracking data;
at a modifying unit, modifying the scheduling profile based on the gesture data; and
at a scheduling profile display data generating unit, generating scheduling profile display data representing the modified scheduling profile, and outputting the modified scheduling profile display data for display by the display unit.
